(19) United States
(12) Patent Application Publication
(10) Pub. No.: US 2026/0269852 A1
(43) Pub. Date: Sep. 10, 2026

(54) COMPACT FREQUENCY SPECTRUM DETECTOR

(71) Applicant: Allegro MicroSystems, LLC, Manchester, NH (US)

(72) Inventors: Pedro Julian, Bahia Blanca (AR); David J. Haas, Concord, NH (US)

(73) Assignee: Allegro MicroSystems, LLC, Manchester, NH (US)

(21) Appl. No.: 19/073,639

(22) Filed: Mar. 7, 2025

(51) Int. Cl. H04B 1/04; H04L 25/02

(52) U.S. Cl. CPC H04B 1/0475; H04L 25/0212

(57) ABSTRACT

In one aspect, a compact frequency spectrum detector includes one or more digital signal processing blocks configured to receive a digital signal and output information about at least one frequency component of the digital signal using a filter, wherein the at least one frequency component is specified by an index, wherein the one or more digital signal processing blocks are configured to calculate at least one constant based on the index by approximating a trigonometric function using a second order expansion of the trigonometric function, wherein the at least one constant is provided as input to the filter. In another aspect, a system includes an artificial intelligence (AI) agent and a plurality of sensors each having a compact frequency spectrum detector configured to compute information about at least one frequency component of a digital signal and transmit the computed information to the AI agent.

### BACKGROUND

The increasing demand for integrating machine learning (ML) and artificial intelligence (AI) capabilities into resource-constrained devices, such as wearable/compact sensors, IoT devices, and energy-efficient automotive systems, necessitates hardware-efficient signal processing solutions. A large family of ML/AI algorithms, including those to detect anomalies or predict/classify operation modes including failures, rely on the availability of the frequency spectrum of a signal. This is normally implemented by a Discrete Fourier Transform (DFT) after the analog signal has been digitized by an analog-to-digital converter (ADC or A/D converter).

### SUMMARY

Due to reasons of cost, area or power requirements, there are cases where a full DFT is not feasible. One such case would be a complex system like a car, with hundreds of small inexpensive sensors.

Disclosed herein are embodiments of systems, devices, processors, and circuits and methods for computing single frequency components, one at a time, and then computing an average and/or another statistical feature to be compared with normal/expected values and/or broadcasted to an external unit for further computation. In some embodiments, the first computation can be performed by a first block and the second computation can be performed by a second block. Disclosed embodiments enable monitoring and analysis of complex systems, based on the spectral information gathered from many low-cost sensors (e.g., hundreds of sensors).

As used herein, “block” can refer to a collection of components arranged or otherwise configured to perform certain processing described in conjunction with the block. In some examples, a block may correspond to a digital signal processing block (or “digital block”). In other examples, a block may correspond to a digital processor. In other examples, a block may correspond to an analog circuit. A block may be realized on an integrated circuit (IC) die. A block can be characterized, in part, based on the minimum die area required to implement the block.

In some embodiments, the single-frequency components of the spectrum can be computed or otherwise calculated using a digital infinite impulse response (IIR) filter based on the equations of the Goertzel algorithm, without requiring an input buffer. Instead, input values from the ADC can be fed directly into the IIR filter, eliminating the need for intermediate storage and thereby reducing memory requirements.

Typically, the Goertzel algorithm is applied to a set of samples stored in a buffer, allowing computation of all spectral components using the same input sequence. This may be necessary when analyzing signals that change rapidly over time, especially when consistency across sampling windows is critical. However, in scenarios involving slowly varying phenomena, such as the gradual degradation of mechanical or electrical components or system changes due to failures, it can be equally effective to compute spectral components using input sequences taken at different times. The spectral characteristics of such systems change so slowly that the spectrum remains consistent across different time samples, making it unnecessary to rely on a single buffered sequence. For example, the degradation of a gear or a fault such as a missing tooth can be reliably identified through spectral analysis, even when the input sequences used to compute different spectral components are spaced minutes or hours apart. Disclosed embodiments reduce the complexity of implementation while maintaining sufficient diagnostic accuracy for slow time-varying effects.

This disclosure addresses key aspects for defining a compact and efficient implementation of an IIR filter. Specifically, a detailed quantization analysis is presented that yields three main results: The first one is that in order to implement an N-point FFT via the Goertzel algorithm, the functions cos(x) and sin(x) required by the algorithm must be quantized with at least

$$2 \times ( {log}_{2} N / 4 - 1 ) \qquad ( 1 )$$

bits.

The second result is that the maximum value of the digital filter, namely v, which indicates the size of the internal registers and operators, with input s is:

$${max ( v ) \vert}_{\vert s \vert \leq 1} = 0.5 \times ( {N}^{2} + N ) . \qquad ( 2 )$$

The third result is that the maximum value of the real and imaginary parts of the FFT, which constitute the output of the Goertzel filter needs only log₂(N)+1 bits to maintain precision.

According to some embodiments, a method is provided for efficiently computing values of cos(θ) and sin(θ), which can be implemented in a compact block. Conventionally, the calculation of these two trigonometric functions for each frequency of interest are performed using a matrix rotation that is the basis of the CORDIC algorithm, which uses an angle θ=tan⁻¹(2^{-t}), starting from t=0, that is iteratively reduced until the desired angle is sufficiently close. Disclosed embodiments use a trigonometric approach for the cosine and sine of small angles that allows the precision required by the Goertzel filter. The methodology used does not require multiplications since all products involve powers of two, so that they can be implemented with shifts producing an extremely compact solution. The area requirement (e.g., required die area) of the algorithm is herein compared with a standard look-up table and shows exponential improvements for FFTs of more than N=256 points.

According to embodiments of the present disclosure, a compact frequency spectrum detector is provided that can be incorporated with minimum area impact in various devices having an ADC. The frequency spectrum detector can be implemented as one or more digital blocks within a digital signal processor (DSP). The compact frequency spectrum detector can compute values (e.g., amplitudes) of individual frequency components using a digital filter based on the Goertzel algorithm. The calculated values of the individual frequency components can be compared with reference values (e.g., normal or expected values or ranges of values) for on-device anomaly detection and/or provided to an external unit for further processing. In some embodiments, the compact frequency spectrum detector can compute values of one or more statistical features (e.g., an average) of the individual frequency components, and the statistical feature values can be compared with reference values on-device and/or provided to an external unit or system (e.g., an ML/AI system configured to use the spectral components as input features to perform classification, regression, anomaly detection, etc.). In some embodiments, the compact frequency spectrum detector can calculate or otherwise determine the reference values during operation, store the reference values to memory, and use the stored reference values for anomaly detection during subsequent operation. In some embodiments, the compact frequency spectrum detector can calculate or otherwise determine the reference values in response to an external signal (e.g., a user signal received via a device pin). In some embodiments, the compact frequency spectrum detector may approximate the cosine and sine calculations required by the Goertzel algorithm using techniques disclosed herein that do not involve multiplication operations or multiple iterations.

According to one aspect of the present disclosure, a frequency spectrum detector includes one or more digital signal processing blocks configured to receive a digital signal and output information about at least one frequency component of the digital signal using a filter, wherein the at least one frequency component is specified by an index, wherein the one or more digital signal processing blocks are configured to calculate at least one constant based on the index by approximating a trigonometric function using a second order expansion of the trigonometric function, wherein the at least one constant is provided as input to the filter.

According to another aspect of the present disclosure, a system includes a frequency spectrum detector and a block external from the frequency spectrum detector, wherein the frequency spectrum detector includes one or more digital signal processing blocks configured to receive a digital signal and output information about at least one frequency component of the digital signal using a filter, wherein the at least one frequency component is specified by one or more constants associated, wherein the frequency spectrum detector receives the one or more constants from the external block.

According to another aspect of the present disclosure, a system includes an artificial intelligence (AI) agent and a plurality of sensors each having a frequency spectrum detector configured to compute information about at least one frequency component of a digital signal and transmit the computed information to the AI agent.

In some embodiments of a frequency spectrum detector, the one or more digital signal processing blocks include the following blocks to approximate the trigonometric function: a first register; a second register coupled to the first register; a first shift block coupled to the first register; a first difference block having a first input coupled to the first register and a second input coupled to the output of the first shift block; a second shift block coupled to an output of the first difference block; and a second difference block having a first input coupled to the second register, a second input coupled to an output of the second shift block, and an output coupled to the first register.

In some embodiments of a frequency spectrum detector, the filter is a Goertzel filter. In some embodiments of a frequency spectrum detector, the at least one constant includes a first constant and a second constant, wherein the one or more digital signal processing blocks are configured to calculate the first constant by approximating a cosine function and to calculate the second constant by approximating a sine function. In some embodiments of a frequency spectrum detector, the information about at least one frequency component of the digital signal includes an amplitude of the frequency component. In some embodiments of a frequency spectrum detector, the information about at least one frequency component of the digital signal includes a value of a statistical feature of the frequency component. In some embodiments of a frequency spectrum detector, the statistical feature is an average.

In some embodiments of a frequency spectrum detector, the information about the frequency component includes at least one value, wherein the one or more digital signal processing blocks are configured to compare the frequency component value to a reference value to detect an anomaly. In some embodiments of a frequency spectrum detector, the information about the frequency component includes at least one value, wherein the reference value is stored in a memory. In some embodiments of a frequency spectrum detector, the one or more digital signal processing blocks are configured to compute the reference value and store it in the memory. In some embodiments of a frequency spectrum detector, the at least one frequency component includes a plurality of frequency components, wherein the one or more digital signal processing blocks are configured to output information about each of the plurality of frequency components, one at a time, using the filter.

In some embodiments of a system, an analog-to-digital converter (ADC) can be provided and configured to convert an analog signal to a digital signal input to a frequency spectrum detector.

In some embodiments of a system, the frequency spectrum detector of at least one of the plurality of sensors includes: one or more digital signal processing blocks configured to receive the digital signal and output the information about the at least one frequency component of the digital signal using a filter, wherein the at least one frequency component is specified by an index, wherein the one or more digital signal processing blocks are configured to calculate at least one constant based on the index by approximating a trigonometric function using a second order expansion of the trigonometric function, wherein the at least one constant is provided as input to the filter.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a block diagram of an illustrative sensing system utilizing a compact frequency spectrum detector (FSD), according to embodiments of the present disclosure.

FIG. 2 is a block diagram showing an implementation of the Goertzel algorithm that may be provided within an FSD, according to some embodiments.

FIG. 3 is a block diagram showing an example of a compact FSD, according to some embodiments.

FIG. 4 is a block diagram showing an example of system in which a plurality of sensors implementing a compact FSD can collectively provide input to a ML/AI application, according to some embodiments.

FIG. 5 is a graphical diagram showing quantization of a cosine function.

FIG. 6 is a graphical diagram showing quantization of frequency peaks of a cosine function.

FIG. 7 is a graphical diagram showing frequency error associated with quantization of a cosine function.

FIG. 8 is a graphical diagram showing absolute value of the magnitude of internal variables of an IIR Goertzel filter.

FIG. 9 is a block diagram showing an example of an IIR Goertzel filter for N=256, according to some embodiments.

FIG. 10 is a block diagram of an illustrative digital block for calculation of a cosine function, according to some embodiments.

FIG. 11 is a block diagram of a compact FSD wherein the coefficients a and b are received externally in an on-demand fashion, according to some embodiments.

FIG. 12 is a graphical diagram showing total area for different implementations of a digital Goertzel filter block.

FIG. 13 is a graphical diagram showing side length for different implementations of a digital Goertzel filter block.

The drawings are not necessarily to scale, or inclusive of all elements of a system, emphasis instead generally being placed upon illustrating the concepts, structures, and techniques sought to be protected herein.

### DETAILED DESCRIPTION

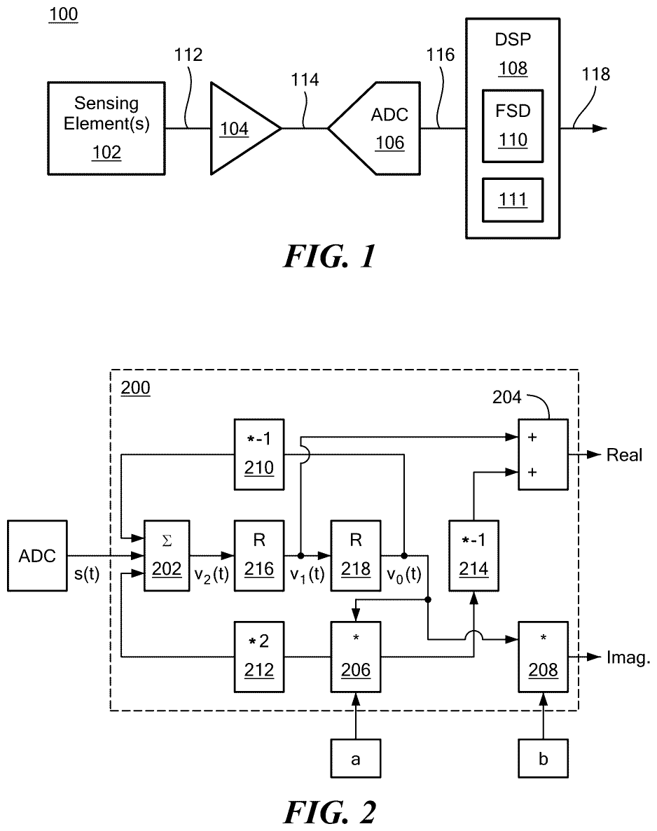

FIG. 1 shows an example sensing system 100 having a compact Goertzel-based frequency spectrum detector (FSD), according to embodiments of the present disclosure. Illustrative system 100 includes one or more sensing elements 102, one or more amplifiers 104, one or more analog-to-digital converters (ADCs) 106, and a digital signal processor (DSP) 108 including at least a compact FSD 110. In some embodiments, sensing element 102, amplifier 104, and ADC 106 may correspond to a first sensing channel, and system 100 can include at least one other sensing channel similarly arranged. That is, DSP 108 can operate on multiple signals received via multiple channels. For convenience, only a single channel is shown in FIG. 1.

A sensing element 102 can include one or more devices configured to generate a sensed signal 112 having an amplitude (e.g., a current or voltage) responsive to a physical quantity of interest (e.g., position or speed of an object, current through a wire, etc.). In some embodiments, sensing elements 102 can include one or more magnetic field sensing elements configured to measure a magnetic field directly or indirectly related to the quantity of interest. For example, a magnetic field sensing element may be arranged to measure a magnetic field produced by a rotating object (e.g., a fan, motor, gear, shaft, etc.) having one or more magnetic or ferromagnetic features. As another example, a magnetic field sensing element may be arranged to measure a magnetic field produced by an electrical current through a wire. The object and wire described used in these examples is not shown in the figure.

As used herein, the term “magnetic field sensing element” is used to describe a variety of electronic elements that can sense a magnetic field and generate a magnetic field signal responsive thereto. The magnetic field sensing element can be, but is not limited to, a Hall-effect element, a fluxgate, a magnetoresistance element, or a magnetotransistor. As is known, there are different types of Hall-effect elements, for example, a planar Hall element, a vertical Hall element, and a Circular Vertical Hall (CVH) element. As is also known, there are different types of magnetoresistance elements, for example, a semiconductor magnetoresistance element such as an Indium Antimonide (InSb) element, a giant magnetoresistance (GMR) element, for example, a spin valve, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

As is known, some of the above-described magnetic field sensing elements tend to have an axis of maximum sensitivity parallel to a substrate that supports the magnetic field sensing element, and others of the above-described magnetic field sensing elements tend to have an axis of maximum sensitivity perpendicular to a substrate that supports the magnetic field sensing element. In particular, planar Hall elements tend to have axes of sensitivity perpendicular to a substrate, while metal based or metallic magnetoresistance elements (e.g., GMR, TMR, AMR) and vertical Hall elements tend to have axes of sensitivity parallel to a substrate.

Other non-limiting examples of sensing elements 102 include optical sensing elements (e.g. photoresistors, photodiodes) and vibration sensing elements (e.g. piezoelectric accelerometers, MEMS). Disclosed structures and techniques are limited to any specific implementation of the sensing elements 101.

DSP 108 may include any suitable type and arrangement of electronic circuitry configured to implement and perform various techniques described herein in conjunction with DSP 108, including but not limited to compact Goertzel-based frequency spectrum detection provided by FSD 110. That is, FSD 110 may be implemented as one or more digital blocks within DSP 108. In some embodiments, DSP 108 may include, or otherwise have access to, a memory 111 such as an EEPROM (electrically erasable programmable read-only memory). DSP 108 may be operated in cycles clocked using a signal generated by an internal or external clock (not shown).

The various components of system 100 may be provided on an integrated circuit (IC) package (or “device”). The device can include one or more pins for receiving signals from, or transmitting signals to, an external unit or system. Taking advantage of the compact and efficient frequency spectrum detection structures and techniques disclosed herein, the device may be realized with smaller size (e.g., surface area), lower cost, and/or lower power rating compared to existing devices that perform frequency spectrum detection (e.g., existing sensors with anomaly detection capability).

FSD 110 can implement and execute various frequency spectrum detection structures and techniques described herein. Briefly, and by way of example, FSD 110 can compute values (e.g., amplitudes) of individual frequency components of a digital signal, compare the frequency component values to reference values (e.g., normal or expected values or ranges of values) for on-device anomaly detection, and/or provide information about the detected frequency components to an external unit for further processing. In some embodiments, FSD 110 can compute values of one or more statistical features (e.g., an average) of the individual frequency components, and the statistical feature values can be compared with reference values on-device and/or provided to an external unit or system (e.g., an ML/AI system configured to use the spectral components as input features to perform classification, regression, anomaly detection, etc.). In some embodiments, FSD 110 can calculate or otherwise determine the reference values during operation, store the reference values to memory 111, and use the stored reference values for anomaly detection during subsequent operation. In some embodiments, the FSD 110 can calculate or otherwise determine the reference values in response to an external signal (e.g., a user signal received via a device pin). In some embodiments, system 100 may be configured such that an external unit or system can directly write the reference values to memory 111.

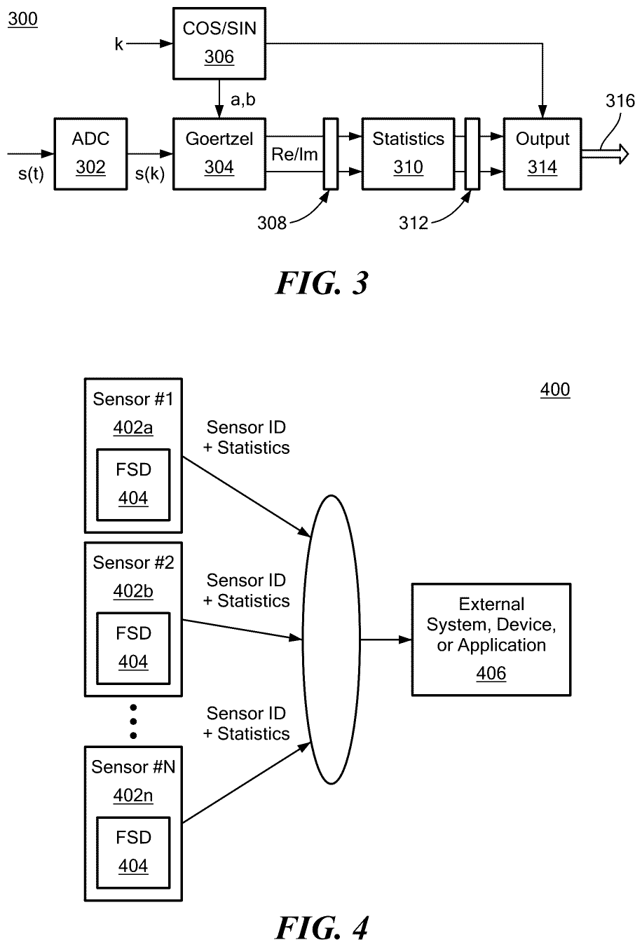

During operation, a sensing element 102 can generate sensed signal 112 having an amplitude responsive to a physical quantity of interest, amplifier can amplify sensed signal 112 to produce an amplified signal 114, and ADC 106 can may digitize amplified signal 114 to produce a digital signal 116. DSP 108 can receive and process digital signal 116 to generate output 118. In some embodiments, output 118 can include information about individual frequency components detected by FSD 110, calculated statistical feature values of those frequency components, and/or detected anomalies. Specific examples of values may be output by system 100 are described below in conjunction with other figures (e.g., FIG. 3).

While FIG. 1 illustrates use of a compact Goertzel-based FSD within a sensing system, the various structures and techniques disclosed herein are not limited to use in sensing applications. In general, disclosed structures and techniques can be used in any application where there is a need to detect frequency spectrum of a signal, including but not limited to wearable/compact sensors, smart sensors, IoT devices, energy-efficient automotive systems, etc.

An overview and analysis of the Goertzel algorithm is next described.

The Goertzel algorithm can be expressed by the following set of equations:

$${v}_{0} ( t ) = {v}_{1} ( t - 1 ) \qquad ( 3 )$$

$${}_{1} ( t ) = {v}_{2} ( t - 1 )$$

$${v}_{2} ( t ) = s ( t ) + 2 cos ( {θ}_{k} ) {v}_{1} ( t ) - {v}_{0} ( t )$$

where s(t) is the input signal, t is the discrete time, θₖ=2πk/N, N is the total number of sampling points of signal s, and k∈{0, . . . , N/2} is the index to the frequency component to be found.

After N steps, the real and imaginary parts of the FFT can be calculated as:

$${Re}_{k} = {v}_{2} ( N ) - {v}_{2} ( N - 1 ) cos ( {θ}_{k} ) \qquad ( 4 )$$

$${Im}_{k} = {v}_{2} ( N - 1 ) sin ( {θ}_{k} )$$

Equation (3) can be expressed in the discrete frequency domain as follows:

$$z {v}_{2} = s + 2 cos ( {θ}_{k} ) {v}_{2} - {z}^{- 1} {v}_{2} \qquad ( 5 )$$

In transfer function (TF) notation:

$$H ( z ) = \frac{{v}_{2}}{s} = \frac{z}{{z}^{2} - 2 cos ( {θ}_{k} ) z + 1} \qquad ( 6 )$$

This transfer function has one zero at zero, and two poles at:

$$z = cos ( {θ}_{k} ) \pm j \sqrt{1 - {cos ( {θ}_{k} )}^{2}} \qquad ( 7 )$$

Except when cos(θₖ)=1 the poles are complex conjugate, located at:

$${ω}_{k} = {tan}^{- 1} \frac{\sqrt{1 - {cos ( {θ}_{k} )}^{2}}}{cos ( {θ}_{k} )} \qquad ( 8 )$$

Considering that 1−cos(θₖ)²=sin(θ)², (8) can be written as:

$${ω}_{k} = {θ}_{k} = \frac{2 π k}{N} \qquad ( 9 )$$

In other words, the filter is a resonant filter, with resonant frequency at 2πk/N. So, by changing k, we can tune to different frequencies and obtain the amplitude of the input signal at that particular frequency. Doing this, one frequency at a time, allows the construction of the frequency spectrum of the input signal.

Referring to FIG. 2, provided s(t) is a digital signal, the Goertzel algorithm can be implemented by illustrative digital block 200. Digital block 200 can include the following elements: adders 202, 204, multipliers 206, 208, scaling blocks 210, 212, 214, and registers 216, 218. The various elements of digital block 200 can be connected such as shown in the figure.

As inputs, adder 202 can receive digital signal s(t), multiplier 206 can receive coefficient a, and multiplier 208 can receive coefficient b, where

$$a = cos ( 2 π k / N ) \qquad ( 10 )$$

$$b = sin ( 2 π k / N ) \qquad ( 11 )$$

and k is the index to the frequency component to be detected.

Adder 202 is configured to sum the digital signal s(t) with the output of scaling block 210 and the output of scaling block 212. Register 216 is configured to hold the output of adder 202 and register 218 is configured to hold the output of register 216. Multiplier 206 is configured to multiply the output of register 218 by the constant a. Block 212 is configured to scale (i.e., multiply) the output of multiplier 206 by two (2). Block 210 is configured to scale the output of register 218 by negative one (−1) and block 214 is configured to scale the output of multiplier 206 by negative one (−1). Adder 204 is configured to sum the output of register 216 with the output of scaling block 214. Multiplier 208 is configured to multiply the output of register 218 by the constant b.

As outputs, adder 204 can provide the real part of the detected frequency component (“Real”) and multiplier 208 can provide the imaginary part of the detected frequency component (“Imag”).

Of note, three-input adder 202 may be implemented using two adders (e.g., two VLSI adders) each having two inputs arranged in cascade. That is, a first adder can sum two of the inputs and the second adder can sum the third input with the output of the first adder. Thus, illustrative block 200 can be implemented using two multipliers and three adders. Since the product to obtain the real part of the FFT can be performed at the end of the computation cycle, in some embodiments, multiplier 208 may be omitted and multiplier 206 may be re-used to perform its function.

FIG. 3 shows an example of a compact Goertzel-based FSD 300, according to some embodiments. FSD 300 of FIG. 3 may, for example, be the same as or similar to FSD 110 of FIG. 1. Illustrative FSD 300 includes an ADC 302, a Goertzel filter 304, a COS/SIN computation block 306, a first register 308, a statistical feature computation block 310, a second register 312, and an output block 314. As input, FSD 300 receives an input signal s(t) and an index k corresponding to a frequency component of the input signal to be detected.

Input signal s(t) is converted to digital by ADC 302 and then then fed directly, without registers, to Goertzel filter 304. Goertzel filter 304 may be implemented as in FIG. 3, for example. COS/SIN computation block 306 computes coefficients (or “constants”) a and b based on index k, and provides these two constants to Goertzel filter 304. Filter 304 produces the real (“Re”) and imaginary (“Im”) part of the frequency/spectral component specified by k. The real and imaginary parts may be expressed as numerical values (e.g., amplitudes). In some cases, FSD 300 can be used to detect multiple spectral components. For example, filter 304 can be operated to produce the real and imaginary part of each spectral component, one by one. In more detail, a value of k can be selected or set, and the Goertzel algorithm can be run for N cycles to produce the real and imaginary parts corresponding to the k-th frequency. This process can then be repeated for a different value of k, and so on. In some cases, the Goertzel algorithm can be run for the same value of k over consecutive N-cycle periods to compute a time average, for example.

Every N cycles, the output of filter 304 can be sampled at first register 308 and provided as input to statistical feature computation block 310. Statistical feature computation block 310 is configured to compute values of one or more statistical features—e.g., such as average, mean, mode, median, and/or standard deviation (STD)-based on the value of first register 308. In some embodiments, block 310 may compute a statistical feature from the calculated real part (“Re”). In some embodiments, block 310 may compute a statistical feature from the calculated imaginary part (“Im”). In some embodiments, block 310 may compute a statistical feature using both the real and imaginary parts, for example by combining them to obtain an amplitude and phase value, and then computing a statistical feature of the combined value.

Every T cycles, the output of statistical feature computation block 310 can be sampled at second register 312. T can be selected or set as an integer multiple of N, and represents the period of time over which block 310 accepts inputs from Goertzel filter 304 block to compute statistics. In some embodiments, statistical feature computation block 310 can compute a single statistical feature based on multiple values calculated for the same frequency k at different times (e.g., k₁ at time zero, k₁ at time N, k₁ at time 2N, etc.). In some embodiments, statistical feature computation block 310 can compute a single statistical feature based on values calculated for multiple different frequencies (e.g., k₁, k₂, . . . , k_{T}). In some embodiments, different weights may be applied to different frequency components to detect a particular system behavior. For example, a weighted sum (or average or other statistical feature) of a third harmonic and a fifth harmonic can indicate undesirable vibration in a rotating axle. In some cases, such weights may be programmed or otherwise set within the compact FSD. In other cases, the weights may be provided to the FSD by an external “master” block such as shown in FIG. 11. In some cases, the weights may be obtained from a ML algorithm and then set within, or otherwise provided to, the compact FSD.

Output block 314 can obtain one or more statistical feature values from second register 312 and provide an output 316 based thereupon.

In some embodiments, output 416 may correspond directly to statistical feature values or encoded forms thereof. For example, a sensor in which FSD 300 is implemented may use output 316 to transmit the statistical feature values to an external system, device, or application configured to perform intensive computation (e.g. to an external ML/AL agent). In some embodiments, the sensor may also transmit metadata to facilitate computation by the external system/device/application. For example, the sensor may transmit a value that uniquely identifies the sensor from among other sensors of a system, referring to herein as a “sensor ID.” As another example, the sensor may transmit the index k to identify the spectral component produced by the Goertzel filter.

Statistical feature values may be output in scalar, vector, or matrix form for example. In the case of a vector, different values of the vector may correspond to different statistical features calculated for the same time period or to the same statistical features calculated over different time periods. In the case of a matrix, each row/column of the matrix can include different statistical features calculated for the same time period, and different rows/columns may correspond to different time periods.

In some embodiments, output block 314 may use the calculated statistical feature values to determine whether an anomalous operating condition exists. For example, output block 314 may compare the calculated statistical feature values to one or more reference values (e.g., normal or expected values or ranges of values) to detect an anomaly. As another example, output block 314 can calculate a difference between the calculated values and reference values for a given frequency component and compare the difference (or absolute value thereof) to a predetermined threshold value to detect anomalies. In any case, output 316 can indicate whether an anomaly exists or not. For example, output 316 can indicate a first value if the calculated values are substantially equal to the reference values, and a second value if the calculated values are substantially different from the reference values.

Thus, the calculated statistical feature values can be used for computationally inexpensive on device anomaly detection, or transmitted off device for use in more intensive computation. A serial protocol may be used to transmit data off-sensor, including but not limited to UART (Universal Asynchronous Receiver/Transmitter), SPI (Serial Peripheral Interface), I2C (Inter-Integrated Circuit), SENT (Single Edge Nibble Transmission), RS232, CAN (Controller Area Network), USB (Universal Serial Bus), etc.

In some embodiments, FSD 300 may be operated in an autonomous fashion to detect anomalies within multiple frequency components (e.g., all frequency components of a DFT, or select frequency components of interest to a given application). For example, if FSD 300 is implemented within a sensor (e.g., sensing system 100 of FIG. 1), the sensor can cycle through each of the frequency components to determine values of each of the frequency components, or values of one or more statistical features thereof, and compare these values to reference values.

In some embodiments, FSD 300 may be operated in a so-called “programming mode” whereby such reference values are automatically calculated, stored, and used for subsequent anomaly detection. In some embodiments, programming mode may be performed in response to an external signal. For example, it can be enabled by the user with a digital signal applied to a pin of the sensor. In other embodiments, the sensor may automatically enter programming mode during an initial period of operation (e.g., at the beginning of the sensor's lifecycle). After programming mode completes, the sensor can periodically compute and compare values for each of the frequency components with the stored reference values, and generate an alert (e.g., generate a signal on an output pin) if it detects a substantial difference therebetween (i.e., detect an anomaly).

The reference values and threshold values described above may be stored on chip (i.e., the same IC device as FSD 300) or in auxiliary memory. In some embodiments, a reference/threshold value may be hardcoded within a DSP. In some embodiments, reference/threshold value may be programmable within an EEPROM or other type of memory.

Referring to COS/SIN computation block 306, as previously discussed, the coefficients a and b can be calculated from k as in equations (10) and (11). Such cosine and sine calculations can be performed in a DSP using a CORDIC. A conventional CORDIC requires multiple, iterative matrix rotation operations to compute a cosine or sine. It is appreciated therein that conventional CORDIC implementations can be inefficient in terms of cost, area, and/or power. Thus, in some embodiments, COS/SIN computation block 306 can approximate the coefficients a and b from k using techniques described below.

Turning to FIG. 4, according to some embodiments, a system 400 can include a plurality of sensors 402a-n (402 generally) each having a compact FSD 404. Sensors 402 can send (e.g., using wired or wireless communication) the outputs of their local FSD's 404 to an external system 406, as shown. Thus, external system 406 can collect similar data from multiple sensors and perform computation on the combined data that is relatively intensive compared to the computation performed on-sensor. In some embodiments, external system 406 may correspond to an AI agent configured to perform anomaly detection (e.g., using a neural network-based classifier). In automotive applications, external system 406 may correspond to an electronic control unit (ECU), for example. In some embodiments, sensors 402 can include hundreds of sensors. In some embodiments, individual ones of the sensors 402 can generate output data at a rate of 50-60 Hz.

In some embodiments, external system 406 can receive data from various different types of sensors—magnetic field sensors, accelerometers, pressure sensors, etc.—within which compact FSD 404 is implemented.

As shown in the figure, each sensor 402 can transmit its unique Sensor ID along with computed statistical feature values to external system 406. This allows external system 406 to identify which information was received from which sensor, and use data from different sensors to perform sensor data fusion or machine learning algorithms.

In some embodiments, the output of one or more sensors can be collected and used for anomaly detection. For example, the spectrum of a current sensor device measuring the current from a DC fan can be collected from samples of a Goertzel filter. Such a spectrum can be represented in terms of upper and lower statistical bounds, e.g., 3-signal bars. A spectrum can be constructed during (known) normal operation and subsequent compared to another spectrum constructed from data of the same sensor to determine if a device is experiencing an abnormal condition (e.g., if the DC fan is partially obstructed).

Described next are techniques to efficiently compute or otherwise determine the coefficients a and b, along with an analysis of the accuracy needed in their computation, since this directly affects the frequency components of the input signals that can be discriminated. The techniques may be used in conjunction with various systems, devices, circuits, and structures described herein.

The following contributions are provided: a) the specification of the accuracy needed in the computation, since this directly affects the frequency components of the input signals we can discriminate; b) the size of the internal variables of the digital systems in order to avoid overflow or lack of precision; c) and the implementation of the two coefficients a and b in FIG. 3. The first two contributions directly determine the size of the integer and fractional representation of the internal variables of the Goertzel as an IIR filter. The last one is important to obtain a compact silicon realization avoiding storage of the coefficients in a ROM memory, especially for large N.

A first disclosed step is to show that in order to implement an N-point Goertzel, one needs to quantize cos(θₖ) and sin(θₖ) with 2 log₂N/4−1 bits. A second step is to show the sizing of the internal variables of the filter. A third step is to propose a method to compute the values of both trigonometric functions at angles θₖ, for k=1, . . . , N, successively using the value at k to compute the next value at θₖ₊₁. In doing so, the values can be calculated in one shot with no need of several iterations as in the CORDIC case.

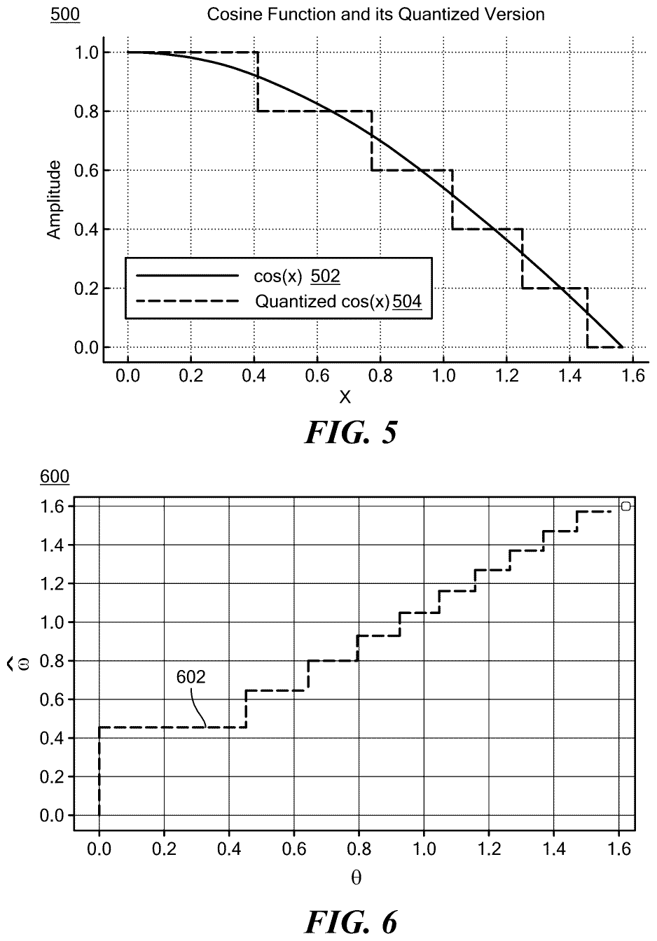

Turning to FIG. 5, analysis of the cos(x) function will now be described. In general, one wants to generate N/2 values for the function in the interval [0,π]. It is appreciated herein that since the negative part can be simply obtained from the positive part, only N/4 values in [0, π/2] are needed. Discretizing the amplitude of cos(θ) between [0,1] with M intervals of size Δ=1/M, the resulting values for the amplitude would be:

$$\text{?} = p Δ ) \qquad ( 12 )$$

where p∈{0, . . . , M}, and θₚ=cos⁻¹(pΔ). This quantization implies that in the interval [θₚ₊₁, θₚ), the function is constant and equal to pΔ. Of note, different alternatives can be chosen, like using the middle point in the interval, but it does not change the error analysis.

In FIG. 5, a graph 500 includes a first curve 502 corresponding to cos(x) and a second curve 504 corresponding to a quantized cos(x) with M=5 quantization intervals.

Using the quantized values for cosine as a replacement in equation (8), one can find the modified frequency peaks for the filters (with the quantized values of cosine):

$${\hat{ω}}_{k} = {tan}^{- 1} \text{?} \qquad ( 13 )$$

This results in the following quantization for the peaks in the frequency response:

$${\hat{ω}}_{k} = {cos}^{- 1} ( {k}_{p} Δ ) \qquad ( 14 )$$

for every θ∈[cos⁻¹ ((kₚ+1)Δ), cos⁻¹(kₚΔ)).

Turning graph 600 of FIG. 6, a curve 602 corresponds to quantization of frequency peaks, with the horizontal axis corresponding to θₖ and the vertical axis corresponding to [symbol] . As can be seen FIG. 6, the closer to zero one is (where cos(x) is flat and approximately equal to 1) the less one can discriminate different frequencies. This difference reduces and becomes constant closer to π/2 where cos(x) is linear. One measure of error, which is useful for the filter design, is the difference in frequency for two consecutive values of θ, i.e.,

$${e}_{ω} = {\hat{ω}}_{{k}_{p}} - {\hat{ω}}_{{k}_{p - 1}} = {cos}^{- 1} ( p Δ ) - {cos}^{- 1} ( ( p - 1 ) Δ ) \qquad ( 15 )$$

This difference indicates the points in frequency where a valid value for the FFT can be obtained.

Performing a Taylor expansion of cos⁻¹(x) around x=pΔ results in:

$${cos}^{- 1} ( p Δ + Δ ) = {cos}^{- 1} ( p Δ ) - \frac{1}{{\sqrt{1 - ( p Δ} )}^{2}} Δ \qquad ( 16 )$$

Thus, the error in (15) can be written as follows:

$${e}_{ω} = - \frac{1}{{\sqrt{1 - ( p Δ} )}^{2}} Δ \qquad ( 17 )$$

Assume that q bits are to be used for amplitude quantization, so that Δ=2^{-q}, with p⊂{0, . . . , 2^{q}−1}, and normalize the error to the interval [0,π/2]::

$$\vert {e}_{ω}^{′} \vert = \frac{2 {2}^{- q}}{π \sqrt{1 - {( p {2}^{- q} )}^{2}}} = \frac{2}{π \sqrt{{2}^{2 q} - {p}^{2}}} \qquad ( 18 )$$

For p=0, (18) results in

$${e}_{ω}^{′} = 2 \frac{{2}^{- q}}{π} \approx {2}^{- q - 0.65} ,$$

whereas for p=2^{q}−1 the error is:

$$\vert {e}_{ω}^{′} \vert = \frac{2}{π \sqrt{{2}^{q + 1} - 1}} \approx 2 {2}^{- \frac{q + 1}{2}} / π \approx {2}^{- \frac{q}{2} - 1.15} \qquad ( 19 )$$

that can be rounded to

$$\vert {e}_{ω}^{′} \vert \approx {2}^{- \frac{q}{2} - 1}$$

In other words, for angles close to π/2, quantization in 2^{q} levels produce an error equivalent to (q+0.65)-bit quantization in frequency, whereas for angles close to 0, the error is equivalent to

$$\frac{q}{2} + 1 - bit$$

quantization in frequency. As an example, if an equivalent 8-bit error (256 levels) is desired for the frequency discrimination (corresponding to the angle range ([0, π/2]), then the amplitude should be discretized with 14 bits.

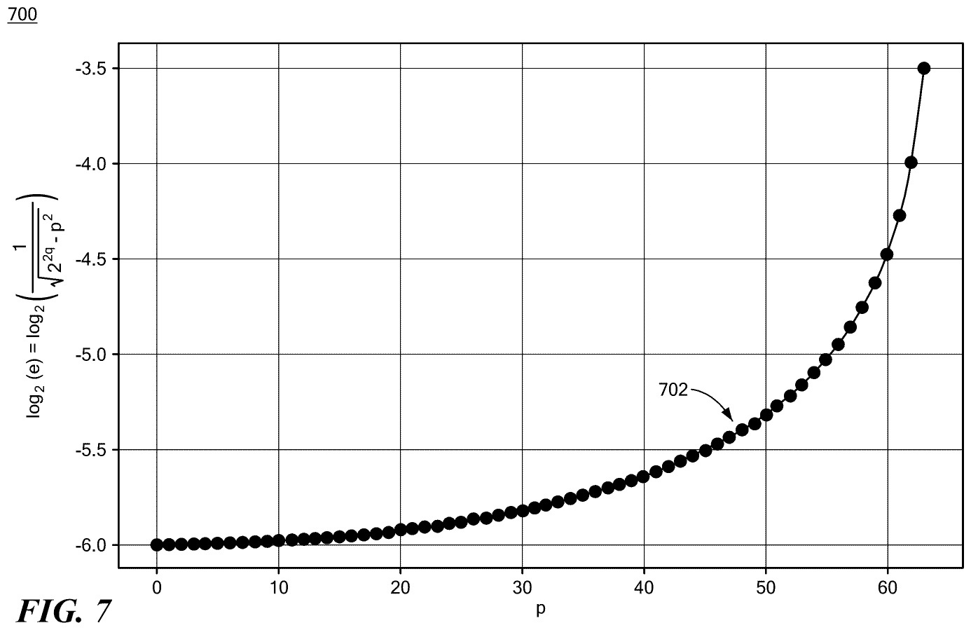

In graph 700 of FIG. 7, curve 702 shows frequency error e_{ω} as a function of p for the case of q=6.

In summary, if we wish an l-bit discrimination in frequency, we need to use 2×(l−1) bits for quantization of cos(x) (positive values in [0, π/2]).

In the particular case of the Goertzel filter, if we need N spectral values at angles 2πk/N, we have to produce N/4 values for cos(x) in the interval [0,π/2]. In accordance with the previous results, for achieving N/4 different levels (represented with log₂(N/4)=n−2 bits), we will need to sample the amplitude of cos(x) with 2×(log₂(N/4)−1) bits, i.e.,

$$2 \times ( n - 3 ) bits \qquad ( 20 )$$

where n=log₂(N).

A second step to implementing a Goertzel filter can be to estimate the values of the internal variables to size the filter accordingly. From numerical experiments, the maximum values of the internal signals for different values of N and all possible values of k=0, 1, . . . , N/2 can be obtained.

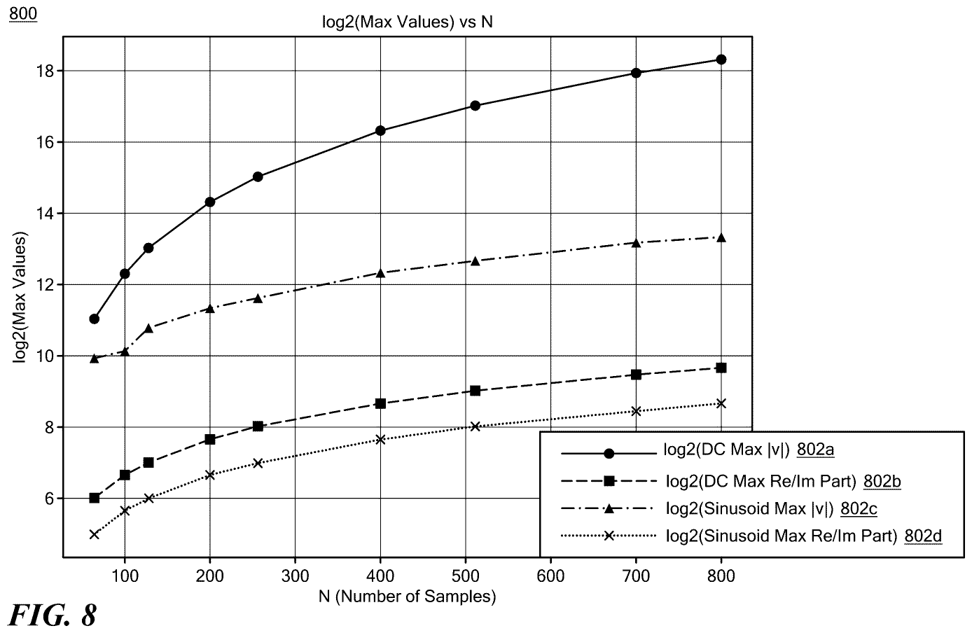

In FIG. 8, a graph 800 illustrates the maximum absolute value of the internal variable v, and the maximum values of the Re/Im parts of v versus the value of N in a log₂ scale, for constant (DC) and sinusoidal inputs. In FIG. 8, max(|s|)=1. In more detail, plot 802a corresponds to the maximum absolute value of v for DC input, plot 802b corresponds to the maximum values of the Re/Im parts of v for DC input, plot 802c corresponds to the maximum absolute value of v for sinusoidal input, plot 802d corresponds to the maximum values of the Re/Im parts of v for sinusoidal input.

Of note, if the k=0 value is skipped, then the maximum occurs for k=1 and is much smaller, the larger N is. This is important, since the DC value can be easily obtained by just averaging samples, and the Goertzel filter becomes significantly smaller if it's stripped of the DC component.

The maximum absolute value of the internal signal as a function of the number of samples N, occurs for a DC signal and k=0, and follows this formula (assuming max(|s|)≤1):

$${max}_{DC} ( v ) = 0.5 \times ( {N}^{2} + N ) \qquad ( 21 )$$

whereas for a sinusoidal, the maximum is:

$${max}_{sin} ( v ) = 7.78 + 1.203 \times N + 8.8 {e}^{- 4} {N}^{2} \qquad ( 22 )$$

The outputs of the filter producing the Real and Imaginary components, can be calculated once the filter has completed N steps using equation (4). These equations produce a value smaller than the maximum value for v. From simulation, they both can be approximated as:

$${max}_{DC} ( Re / Im ( v ) ) = N \qquad ( 23 )$$

Whereas for a sinusoidal, the maximum is:

$${max}_{sin} ( Re / Im ( v ) ) = 0.5 \times N \qquad ( 24 )$$

TABLE 1
Maximum absolute values of internal variables

| N | max_{DC} | Re/Im_{DC} | max_{Sin} | Re/Im_{Sin} |
|---|---|---|---|---|
| 32 | 528.00 | 32.00 | 311.89 | 22.73 |
| 64 | 2080.00 | 64.00 | 968.71 | 32.00 |
| 128 | 8256.00 | 128.00 | 1724.25 | 64.00 |
| 256 | 32896.00 | 256.00 | 3103.56 | 128.00 |
| 512 | 131328.00 | 512.00 | 6420.30 | 256.00 |

TABLE 2
Maximum absolute values of internal variables in bits (log₂)

| N | max_{DC} | Re/Im_{DC} | max_{Sin} | Re/Im_{Sin} |
|---|---|---|---|---|
| 32 | 9.047 | 5.044 | 8.290 | 4.568 |
| 64 | 11.023 | 6.022 | 9.921 | 5.044 |
| 128 | 13.011 | 7.011 | 10.753 | 6.022 |
| 256 | 15.006 | 8.006 | 11.600 | 7.011 |
| 512 | 17.003 | 9.003 | 12.649 | 8.006 |

Tables 1 and 2 summarize these values for different values of N (powers of 2) in absolute and logarithmic scale. From these values, it can be seen that the internal registers need to be sized much larger than the real and imaginary parts to be sent outside the block. Rounding up the numbers in the table and allocating the bit sign, the configuration for each case can look like in Table 3, using the notation (sign bit, Int. bits, Frac. bits):

TABLE 3
Size of internal variable s and Re/Im outputs

| N | v (s, Int, Frac) | Re/Im (s, Int, Frac) |
|---|---|---|
| 32 | 1, 10, 4 | 1, 6, x |
| 64 | 1, 12, 6 | 1, 7, x |
| 128 | 1, 14, 8 | 1, 8, x |
| 256 | 1, 16, 10 | 1, 9, x |
| 512 | 1, 18, 12 | 1, 10, x |
| 1024 | 1, 20, 14 | 1, 11, x |

The size of the integer part of the internal variable s can be defined so as to accommodate the largest possible value, whereas the fractional part is sized to match the accuracy required for quantization of function cos as set by equation (20). The fractional part of the Re/Im parts can be set, depending on the HW limitations, from a minimum of zero to a maximum given by the fractional part of the internal variable v. With these results, the Goertzel filter IIR implementation can be designed provided the value for N has been defined.

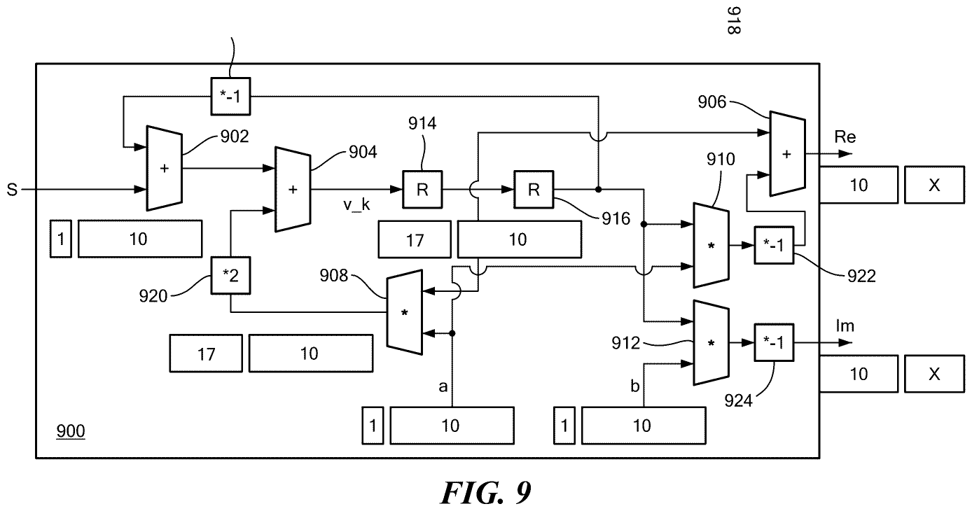

FIG. 9 shows an example of an IIR Goertzel filter 900 for N=256. Illustrative filter 900 includes adders 902, 904, 906, multipliers 908, 910, 912, registers 914, 916, and scaling blocks 918, 920, 922, 924. The various elements of filter 900 can be connected such as shown in the figure. Filter 900 may be implemented as a digital block on a semiconductor die, for example.

As inputs, adder 902 can receive digital signal s(t), multiplier 908 can receive coefficient a, and multiplier 912 can receive coefficient b, where the coefficients can be defined as in equations (10) and (11) for a given index k corresponding to a frequency component to be detected. As outputs, adder 906 can provide the real part of the detected frequency component (“Re”) and scaling block 924 can provide the imaginary part of the detected frequency component (“Im”).

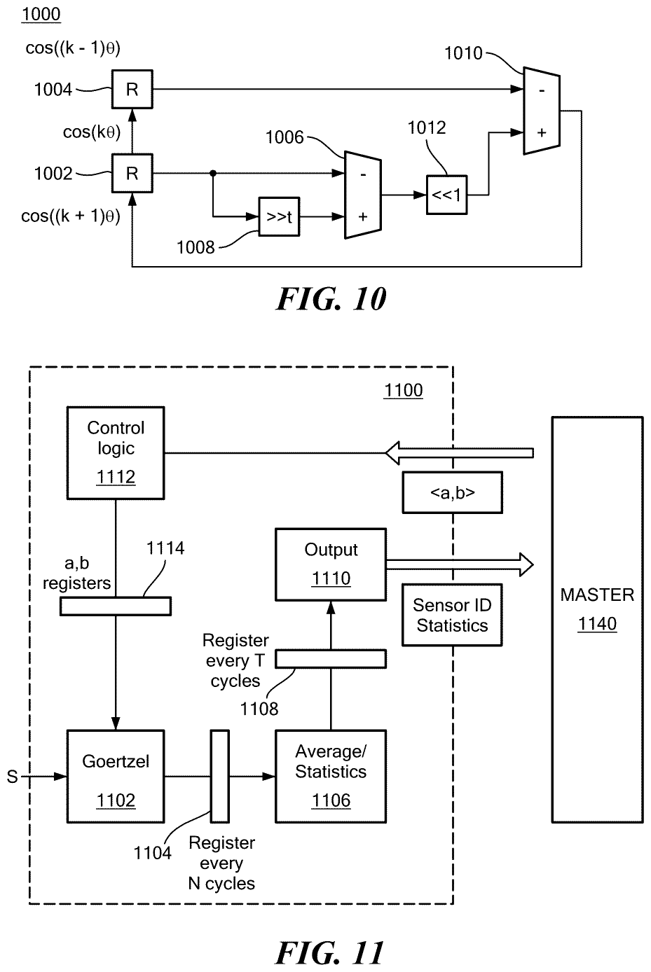

FIG. 10 also illustrates data word sizes used at different stages of the filter. For example, digital input signal s(t) can be represented using digital words having twelve (12) total bits, one bit used to represent the integer part of the signal value and eleven (11) bits used to represent the fractional part of the signal value. The number of fractional bits (“x”) used for the real and imaginary outputs can be configurable (e.g., determined according to a user setting).

A method to efficiently compute cos(x) and sin(x) values is next described. This is referred to herein as the “proposed method.” The proposed method can be implemented, for example, with COS/SIN computation block 306 of FIG. 3. The proposed method avoids iterative matrix rotations required by the conventional CORDIC method.

A method to calculate coefficients a and b can be based on the following trigonometric identities:

$$cos ( A + B ) + cos ( A - B ) = 2 cos ( A ) cos ( B ) \qquad ( 25 )$$

$$sin ( A + B ) + sin ( A - B ) = 2 sin ( A ) cos ( B ) \qquad ( 26 )$$

Setting A=kθ and B=θ,

$$cos ( ( k + 1 ) θ ) = 2 cos ( k θ ) cos ( θ ) - cos ( ( k - 1 ) θ ) \qquad ( 27 )$$

$$sin ( ( k + 1 ) θ ) = 2 sin ( k θ ) cos ( θ ) - sin ( ( k - 1 ) θ ) \qquad ( 28 )$$

θ can be chosen such that cos(θ)=1−2^{-t}, and successive values of cos can be calculated as follows:

$$cos ( 0 ) = 1 \qquad ( 29 )$$

$$cos ( θ ) = 1 - {2}^{- t}$$

$$⋮$$

$$cos ( ( k + 1 ) θ ) = 2 cos ( k θ ) ( 1 - {2}^{- t} ) - cos ( ( k - 1 ) θ )$$

A similar approach can be used to calculate sin, for example by first obtaining sin(cos⁻¹(1−2^{-t})). Alternatively, the following approximation can be used to calculate sin. The approximation is shown to remain stable.

A quadratic expansion for cos around the origin leads to:

$$cos ( θ ) \approx 1 - \frac{1}{2} {θ}^{2} \qquad ( 30 )$$

Since cos(θ)=1−2^{-t}, it follows that

$${2}^{- t} = \frac{1}{2} {θ}^{2} ,$$

so that

$$θ \approx {2}^{( \frac{- t + 1}{2} )} \qquad ( 31 )$$

Using a linear approximation for sin around the origin (θ=0), one obtains:

$$sin ( θ ) \approx {2}^{( \frac{- t + 1}{2} )} \qquad ( 32 )$$

and sin can be calculate iteratively as follows:

$$cos ( 0 ) = 1 \qquad ( 33 )$$

$$cos ( θ ) = 1 - {2}^{- c}$$

$$⋮$$

$$cos ( ( k + 1 ) θ ) = 2 cos ( k θ ) ( 1 - {2}^{- t} ) - cos ( ( k - 1 ) θ )$$

Since only powers of two are involved in the products, values can be calculated using shifts of the digital numbers such as illustrated in FIG. 10. That is, relatively expensive multiplication operations can be avoided.

FIG. 10 shows a digital block 1000 for calculation of cos. Illustrative block 1000 includes a first register 1002 to hold cos(kθ) and a second register 1004 to hold cos((k−1)θ). An output of first register 1002 is connected to one input of a first difference block 1006. The other input of first difference block 1006 corresponds to the output of first register 1002 shifted right by t bits (shift block 1008). An output of second register 1004 is connected to an input of a second difference block 1010. The other input of second difference block 1010 corresponds to the output of first difference block 1006 shifted left by 1 bit (shift block 1012). The output of second difference block 1010, which corresponds to cos((k+1)θ, is fed back into first register 1002 as shown, thereby implementing the iterative technique of equation (29). Digital block 1000 may correspond to at least a portion of COS/SIN computation block 306 of FIG. 3.

Digital block 1000 can also be used to calculate sin using the relationship

$$sin ( θ ) = cos ( θ - \frac{π}{2} ) .$$

Turning to FIG. 11, to provide an even more compact FSD, the coefficients a and b are received externally in an on-demand fashion, according to some embodiments. Similar to the compact FSD of FIG. 4, illustrative FSD 1100 of FIG. 11 includes a Goertzel filter 1102, a first register 1104, a statistical feature computation block 1106, a second register 1108, and an output block 1110, connected as shown. However, in contrast to FIG. 4, FSD 1100 does not include elements to calculate the coefficients a and b. Rather, the FSD 1100 acts as a “slave” block that sits idle until it receives a request to detect a frequency component of digital signal s(t). The request can be received from an external “master” block 1140 and can encode or otherwise include the values of the two coefficients, a=cos(θₖ) and b=sin(θₖ) necessary for the computation. Compact FSD 1100 can further include a control logic block 1112 to coordinate the data transaction with the external master block 1140. Control logic block 1112 can decode or otherwise extract the coeffective values a and b from the request and store these values in registers 1114. FSD 1100 eliminates the need to store/compute the values of a=cos(θₖ) and b=sin(θₖ) for all values of k on chip. External master block 1140 may correspond to a system, device, or IC that is different from a system/device/IC within which FSD 1110 is implemented.

The size of a Goertzel filter may vary depending on how the multipliers and the two coefficients/constants a and b are implemented. Regarding the multipliers (e.g., multipliers 206 and 208 in FIG. 2), they can be implemented with a full parallel (FP) multiplier, with a serial-parallel (SP) multiplier (the multiplicand is stored in registers and the multiplier is fed through a serial register one bit per clock cycle) or with a fully serial (FS) multiplier (where both, multiplier and multiplicand are multiplied bit by bit). Regarding coefficients a and b, they can be stored in ROM, generated with techniques disclosed herein such as in conjunction with equations (25)-(33) and/or FIG. 10, or fed from the outside such as in FIG. 11. Next, an evaluation of the different combinations and their features is provided.

Table 4 shows the number of transistors required for different computational blocks, namely, the Goertzel computation algorithm implemented with a parallel multiplier (FP), with a serial parallel (SP) multiplier, and a fully serial (FS) multiplier; and also the ROM memory for storing a and b and the proposed algorithm to generate them.

TABLE 4
Number of transistors for different blocks as
a function of N: Goertzel computation algorithm
with FP, SP and FS; ROM and cos algorithm

| N | Goert. FP | Goert. SP | Goert. FS | ROM | COS Algo. |
|---|---|---|---|---|---|
| 64 | 5472 | 3192 | 1896 | 224 | 1008 |
| 128 | 7728 | 3864 | 2280 | 576 | 1296 |
| 256 | 10368 | 4536 | 2664 | 1408 | 1584 |
| 512 | 13392 | 5208 | 3048 | 3328 | 1872 |
| 1024 | 16800 | 5880 | 3432 | 7680 | 2160 |
| 2048 | 20592 | 6552 | 3816 | 17408 | 2448 |
| 4096 | 24768 | 7224 | 4200 | 38912 | 2736 |
| 8192 | 29328 | 7896 | 4584 | 86016 | 3024 |
| 16384 | 34272 | 8568 | 4968 | 188416 | 3312 |
| 32768 | 39600 | 9240 | 5352 | 409600 | 3600 |
| 65536 | 45312 | 9912 | 5736 | 884736 | 3888 |
| 131072 | 51408 | 10584 | 6120 | 1900544 | 4176 |
| 262144 | 57888 | 11256 | 6504 | 4063232 | 4464 |

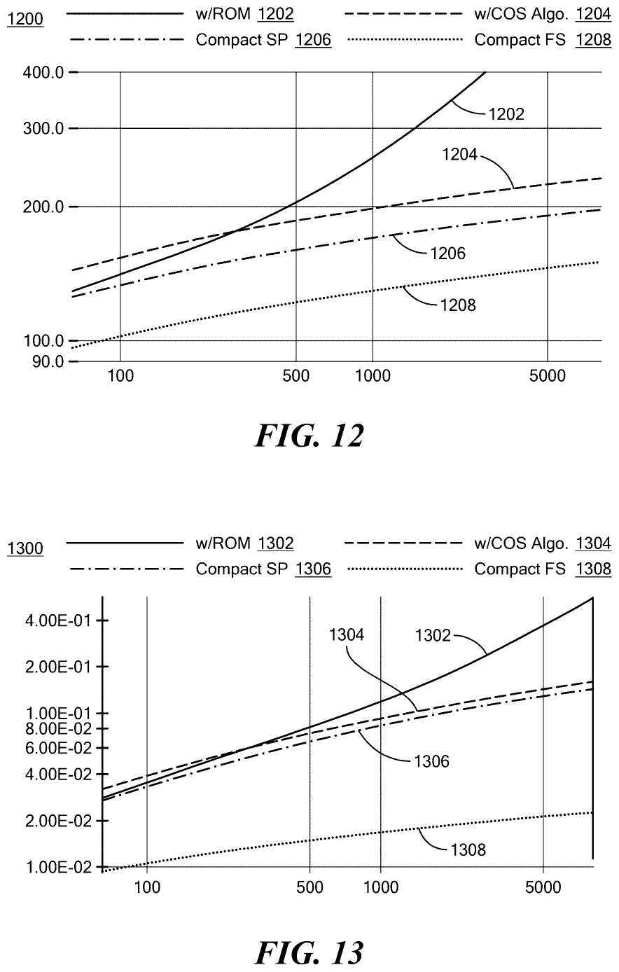

FIG. 12 shows a graph 1200 of total area (mm²) of several versions of the complete Goertzel algorithm in a 0.35 μm technology as a function of N. The figure shows Goertzel FP with ROM storage (plot 1202), Goertzel FP with a disclosed cos technique such as in FIG. 10 (plot 1204), a compact version such as in FIG. 11 with SP multipliers (plot 1206), and a compact version with FS multipliers (plot 1208). Here, “disclosed cos technique” refers to a technique such as in equations (25)-(33) and/or FIG. 10, and “compact version” refers to an approach such as in FIG. 11.

FIG. 13 shows a graph 1300 of side length (μm) of the Goertzel block (0.35 μm technology) as a function of N. The figure shows Goertzel FP with ROM storage (plot 1302), Goertzel FP with the proposed cos algorithm (plot 1304), a compact version with SP multipliers (plot 1306), and a compact version with FS multipliers (plot 1308).

It can be noticed that the compact version is smaller for all cases. In addition, for small N the ROM table is smaller than the algorithm, but for N=256 and higher values the cos algorithm is more convenient. In the case of the serial-parallel multiplier, the compact version is 15% smaller on average than the version with the algorithm. In turn, the compact version with an FS multiplier is 24% smaller than the compact version with the SP multiplier.

TABLE 5
Comparison of side length (μm) of Goertzel blocks

| N | ROM | COS Algo. | Compact SP | Compact FS |
|---|---|---|---|---|
| 64 | 129.4 | 143.5 | 125.1 | 96.4 |
| 128 | 147.5 | 159.0 | 137.6 | 105.7 |
| 256 | 170.7 | 173.2 | 149.1 | 114.3 |
| 512 | 204.5 | 186.3 | 159.7 | 122.2 |
| 1024 | 257.8 | 198.5 | 169.7 | 129.7 |
| 2048 | 342.6 | 210.0 | 179.2 | 136.7 |
| 4096 | 475.5 | 220.9 | 188.1 | 143.5 |
| 8192 | 678.4 | 231.3 | 196.7 | 149.9 |
| 16384 | 982.5 | 241.3 | 204.9 | 156.0 |
| 32768 | 1432.6 | 250.8 | 212.8 | 161.9 |
| 65536 | 2093.7 | 260.0 | 220.4 | 167.6 |
| 131072 | 3060.2 | 268.9 | 227.7 | 173.2 |
| 262144 | 4468.2 | 277.5 | 234.8 | 178.5 |

In summary, the proposed method calculates the cosine an sine trigonometric functions for each frequency of interest using a matrix rotation that is the basis of the CORDIC algorithm, which uses a fixed angle θ=tan⁻¹(2^{-t}), where t=log₂N−1−log₂π and a single computation step (unlike a conventional CORDIC algorithm that requires several iterations). A second order approximation is used for the cosine of small angles that allows the precision required by the Goertzel filter. This computation produces the required values for both trigonometric functions at angles θₖ, for k=1, . . . , N, successively using the value at Ok to compute the next value at θₖ₊₁. The proposed method does not require multiplications since all products involve powers of two, so that they can be implemented with shifts producing an extremely compact solution. However, in doing so, the values are calculated in one shot with no need for several iterations as in a conventional CORDIC.

As used herein, the term “processor” is used to describe electronic circuitry that performs a function, an operation, or a sequence of operations. The function, operation, or sequence of operations can be hard coded into the electronic circuit or soft coded by way of instructions held in a memory device (e.g., EPROM, EEPROM, flash memory device, etc.). The function, operation, or sequence of operations can be performed using digital values or using analog signals. In some embodiments, the processor can be embodied in an application specific integrated circuit (ASIC), which can be an analog ASIC or a digital ASIC, in a microprocessor with associated program memory, in a digital signal processor (DSP), and/or in a discrete electronic circuit, which can be analog or digital. A processor can include internal processors or modules that perform portions of the function, operation, or sequence of operations. Similarly, a module can include internal processors or internal modules that perform portions of the function, operation, or sequence of operations of the module. A single processor or other unit may fulfill the functions of several means recited in the claims.

As used in the claims or elsewhere herein, the term “comprising” does not exclude other elements or steps, and the indefinite article “a” or “an” does not exclude a plurality.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

The subject matter described herein can be implemented in digital electronic circuitry, or in computer software, firmware, or hardware, including the structural means disclosed herein and structural equivalents thereof, or in combinations of them.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the detailed description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

Other variations to the disclosed embodiments can be understood and effected by those skilled in the art in practicing the claimed invention, from a study of the drawings, the disclosure, and the appended claims.

The mere fact that certain measures are recited in mutually different dependent claims does not indicate that a combination of these measures cannot be used to obtain an advantage.

Any reference signs in the claims should not be construed as limiting the scope.

All publications and references cited herein are expressly incorporated herein by reference in their entirety.

1. A frequency spectrum detector comprising:
one or more digital signal processing blocks configured to receive a digital signal and output information about at least one frequency component of the digital signal using a filter, wherein the at least one frequency component is specified by an index, wherein the one or more digital signal processing blocks are configured to calculate at least one constant based on the index by approximating a trigonometric function using a second order expansion of the trigonometric function, wherein the at least one constant is provided as input to the filter.

2. The frequency spectrum detector of claim 1 wherein the one or more digital signal processing blocks include the following blocks to approximate the trigonometric function:
a first register;
a second register coupled to the first register;
a first shift block coupled to the first register;
a first difference block having a first input coupled to the first register and a second input coupled to the output of the first shift block;
a second shift block coupled to an output of the first difference block; and
a second difference block having a first input coupled to the second register, a second input coupled to an output of the second shift block, and an output coupled to the first register.

3. The frequency spectrum detector of claim 1 wherein the filter is a Goertzel filter.

4. The frequency spectrum detector of claim 1 wherein the at least one constant includes a first constant and a second constant, wherein the one or more digital signal processing blocks are configured to calculate the first constant by approximating a cosine function and to calculate the second constant by approximating a sine function.

5. The frequency spectrum detector of claim 1 wherein the information about at least one frequency component of the digital signal includes an amplitude of the frequency component.

6. The frequency spectrum detector of claim 1 wherein the information about at least one frequency component of the digital signal includes a value of a statistical feature of the frequency component.

7. The frequency spectrum detector of claim 6 wherein the statistical feature is an average.

8. The frequency spectrum detector of claim 1 wherein the information about the frequency component includes at least one value, wherein the one or more digital signal processing blocks are configured to compare the frequency component value to a reference value to detect an anomaly.

9. The frequency spectrum detector of claim 8 wherein information about the frequency component includes at least one value, wherein the reference value is stored in a memory.

10. The frequency spectrum detector of claim 9 wherein the one or more digital signal processing blocks are configured to compute the reference value and store it in the memory.

11. The frequency spectrum detector of claim 1 wherein the at least one frequency component includes a plurality of frequency components, wherein the one or more digital signal processing blocks are configured to output information about each of the plurality of frequency components, one at a time, using the filter.

12. A system comprising:
the frequency spectrum detector of claim 1;
an input to receive an analog signal;
an output to transmit the information about one or more frequency components of the digital signal; and
an analog-to-digital converter (ADC) configured to convert the analog signal to the digital signal.

13. A system comprising:
a frequency spectrum detector; and
a block external from the frequency spectrum detector,
wherein the frequency spectrum detector includes one or more digital signal processing blocks configured to receive a digital signal and output information about at least one frequency component of the digital signal using a filter, wherein the at least one frequency component is specified by one or more constants associated, wherein the frequency spectrum detector receives the one or more constants from the external block.

14. A system comprising:
an artificial intelligence (AI) agent; and
a plurality of sensors each having a frequency spectrum detector configured to compute information about at least one frequency component of a digital signal and transmit the computed information to the AI agent.

15. The system of claim 14 wherein the frequency spectrum detector of at least one of the plurality of sensors includes:
one or more digital signal processing blocks configured to receive the digital signal and output the information about the at least one frequency component of the digital signal using a filter, wherein the at least one frequency component is specified by an index, wherein the one or more digital signal processing blocks are configured to calculate at least one constant based on the index by approximating a trigonometric function using a second order expansion of the trigonometric function, wherein the at least one constant is provided as input to the filter.
